(19) United States
(12) Patent Application Publication
(10) Pub. No.: US 2025/0007381 A1
(43) Pub. Date: Jan. 2, 2025

(54) SELF POWERED ELECTRIC GENERATOR DEVICE

(71) Applicant: Jesse Baxter, Gonzales, LA (US)

(72) Inventor: Jesse Baxter, Gonzales, LA (US)

(21) Appl. No.: 18/882,555

(22) Filed: Sep. 11, 2024

Related U.S. Application Data
(60) Provisional application No. 63/631,979, filed on Apr. 9, 2024.

(51) Int. Cl. H02K 53/00; H02K 11/20

(52) U.S. Cl. CPC H02K 53/00; H02K 11/20

(57) ABSTRACT

A self-sustaining electric generation system comprises a battery system, an alternator, an AC electric motor, an inverter, a belt drive, a frame, and a plurality of wires. The system initiates a process of supplying direct current (D/C) power from the battery system to the inverter, which converts the direct current (D/C) power into alternating current (A/C) power. The A/C power is utilized to drive an electric motor, translating electrical energy into mechanical motion through a drive belt, which connects to and propels an alternator. The alternator converts the received mechanical energy from the drive belt back into D/C power, as regenerated power. The regenerated power feeds back into the battery system, replenishing the battery system and maintaining the cycle of energy production.

### CROSS-REFERENCE TO RELATED APPLICATIONS

This application claims the benefit of priority of pending U.S. Provisional Application No. 63/631,979, filed Apr. 9, 2024, the disclosure of which is hereby incorporated by reference in its entirety.

### BACKGROUND OF THE INVENTION

### Field of the Invention

The present invention relates generally to electric power generation systems and more particularly to an improved electric generator power device that is capable of operating without reliance on conventional fuel sources such as gas, diesel, natural gas, propane, or kerosene.

### Description of the Related Art

Electric generators are commonly used to supply electricity in situations where grid power is unavailable or insufficient. Electric generators are employed in both residential and commercial settings, providing a critical backup power source during electrical outages. Conventional electric generators convert mechanical energy into electrical energy, typically through the combustion of fossil fuels such as gasoline, diesel, natural gas, propane, or kerosene. Accordingly, the availability and use of the fuels play a crucial role in the operation and efficiency of these generators.

Although conventional electric generators are widely used, they have several drawbacks. A primary issue is the dependence on the availability and use of fossil fuels. In the event of natural disasters such as hurricanes, floods, or earthquakes, fuel supply chains can be disrupted, rendering such conventional generators inoperative. Furthermore, the combustion of fossil fuels by generators contributes to air pollution and the emission of greenhouse gases, which are detrimental to the environment.

None of the existing electric generators provide a convenient, effective, and efficient way to provide reliable power without the necessity for conventional fossil fuels.

A need also exists for an improved electric generator that can operate independently of traditional fuel sources, thereby mitigating the issues of fuel supply disruption, environmental pollution, and high operational costs.

Conventional electric generators rely on gas, diesel, natural gas, propane, or kerosene for operation, none of such generators disclose the unique structures and advantages of the present disclosure of providing a sustainable and reliable source of power, particularly in emergency situations or during power outages caused by natural calamities.

Accordingly, there is a need for an improved electric generator that offers a more environmentally friendly, cost-effective, and resilient solution for power generation.

It is one prospect of the present invention to provide a novel electric generator that does not take any petroleum products to for operation and produces more power than it takes to operate.

Another object of the present invention is to provide an environmentally friendly electric generator that does not generate fumes.

Yet another object of the disclosed invention is to provide an electric generator that changes a form of D/C power to A/C power.

As disclosed in this application, the inventor has discovered a novel and unique electric generator that can produce and supply power, that is particularly when useful during a conventional grid power outage and there is no accessibility of gas, diesel, natural gas, propane, or kerosene.

Embodiments of the present invention provide for electric generators as described and defined in the description below and in the annexed claims which provide for improved electric generator that does not rely on gas, diesel, natural gas, propane, or kerosene for its operation and provides a sustainable and reliable source of power.

### SUMMARY OF THE INVENTION

The following presents a simplified summary of the present disclosure in a simplified form as a prelude to the more detailed description that is presented herein.

Therefore, in accordance with embodiments of the invention, there is provided a novel self-sustaining electric generator device, designed to provide continuous electrical power to an end user. The self-sustaining electric generator device includes a battery system adapted to supply D/C power. The device includes at least one wire electrically connecting the battery system to an inverter, which is configured to convert the D/C power into A/C power. The device includes an electric motor, a drive belt, and an alternator, all disposed within a frame. In a preferred embodiment, the electric motor, a drive belt, and an alternator are all disposed within a uniquely designed U-shaped frame. The drive belt is rotatably connected to the electric motor, and the drive belt is rotatably connected to the alternator, such that, a rotation of the drive belt by the electric motor rotates the drive belt and thereby causes a rotation of the alternator.

The electric generator device operates by converting direct current (D/C) power from the battery system to alternating current (A/C) power using the inverter, and the A/C power drives the electric motor, producing mechanical motion that is transferred by the drive belt to drive the alternator. The alternator then converts the mechanical energy from the mechanical motion of the drive belt back into D/C power, which D/C power is fed back to the battery system through electrical wiring to recharge the battery system, thus creating a self-sustaining loop of continuous electrical generation by the electric generator device.

Preferably, electric generator device includes a frame that provides a sturdy base and a protective enclosure for the system. In one embodiment, the frame is designed for ease of use and mobility, including a lower horizontal surface for housing and supporting the inverter, motor, and alternator, and including an upper surface for mounting and supporting the battery system.

In one embodiment, the battery system includes a first 12V battery. In a preferred embodiment, the battery system includes and features the first 12V battery and a second 12V battery for enhanced performance and reliability. The battery system generates and supplies D/C power.

In another embodiment, the inverter converts D/C power into A/C power, and the invertor preferably includes a display adapted for monitoring the power status, including voltage output of the inverter, and the inverter also includes a power button for operational control.

In a preferred embodiment, the electric motor that converts A/C power into mechanical motion is capable of generating 115V A/C power and has a dedicated power switch for activation and deactivation.

In a preferred embodiment, the alternator converts mechanical energy (as received from the drive belt) into D/C power for recharging the battery system, providing self-sustainability of the system.

In a preferred embodiment, the battery system transfers direct current (D/C) power to an inverter, the inverter is configured to receive the D/C power and converts the D/C power into A/C power. Utilizing the A/C power, the electric motor is driven to produce mechanical motion, and the drive belt facilitates the transfer of the mechanical energy to the alternator; and with the mechanical energy provided through the drive belt, the alternator is driven to convert this mechanical energy back into D/C electrical power.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 illustrates a left perspective view of a self-sustaining electric generator device, in accordance with embodiments of the invention;

FIG. 2 illustrates a right perspective view of the self-sustaining electric generator device, in accordance with embodiments of the invention;

FIG. 3 illustrates a front perspective view of the self-sustaining electric generator device, in accordance with embodiments of the invention;

FIG. 4 illustrates a rear perspective view of the self-sustaining electric generator device in accordance with embodiments of the invention; and

FIG. 5 illustrates a flow chart of a method of generating electric power, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

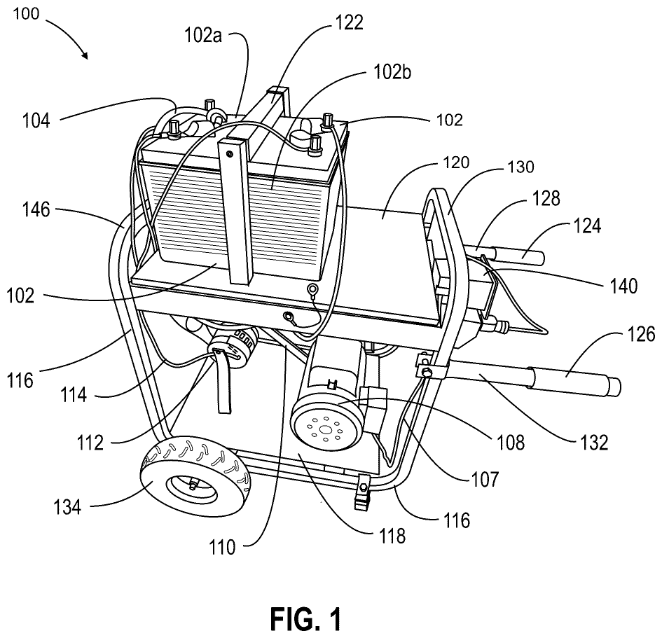

Referring to FIGS. 1-4, in a preferred embodiment, the disclosed self-sustained or self-powered electric generator device 100 includes frame 116. The frame 116 is preferably made of steel or any other insulating lightweight and durable metal and is adapted to carry the electric and mechanical components of the generator system 100, as described herein.

The frame 116 of the electric generator device 100 is preferably U-shaped, and the frame 116 preferably includes a front wall 130 and a rear wall 146. The frame 116 preferably includes horizontal members 148a, 148b joining bottom ends 150a, 150b of the front wall 130 to bottom ends 152a, 152b of the rear wall 146, respectively.

Referring to FIG. 1, the front wall 130 and the rear wall 146 are preferably symmetrical and have similar dimensions.

In a preferred embodiment, the electric generator device 100 includes a first handle 124 that is slidably connected to a first arm 128 of the front wall 130 using a first mechanical fastener 154 and has an ergonomic grip. In another embodiment, the first handle 124 of the electric generator device 100 is telescopically connected to the first arm 128 of the front wall 130 of the electric generator device 100.

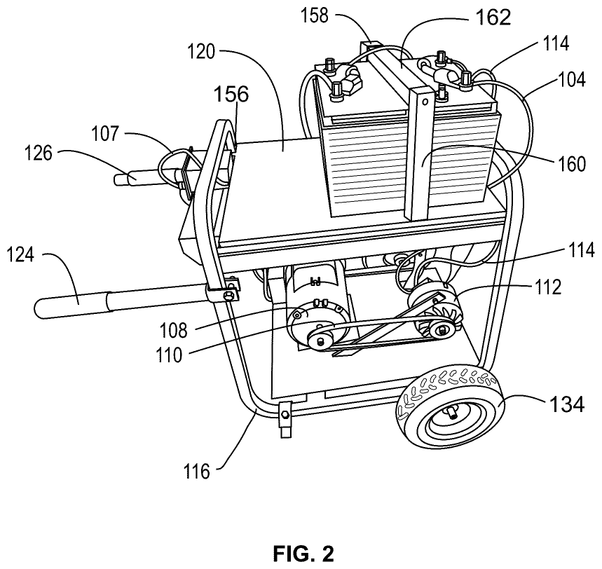

As illustrated in FIG. 2, in a preferred embodiment, the first arm 128 is pivotally connected to the front wall 130 of the frame 116.

In another preferred embodiment, the electric generator device 100 includes a second handle 126 that is slidably connected to a second arm 132, which is pivotally connected to the front wall 130b of the frame 116, as illustrated in FIG. 1. In one embodiment, the second handle 126 is connected to the frame using a second mechanical fastener 156 and has a corresponding ergonomic grip. In another embodiment, the second handle 126 of the electric generator device 100 is telescopically connected to the second arm 132 of the front wall 130 of the electric generator device 100.

In one embodiment, the handles 124,126 are transversal to the arms 128,132, respectively, allowing a user to not only easily maneuver the frame 116 for transporting the generator device 100 between places but also for storing the generator device 100 in small spaces.

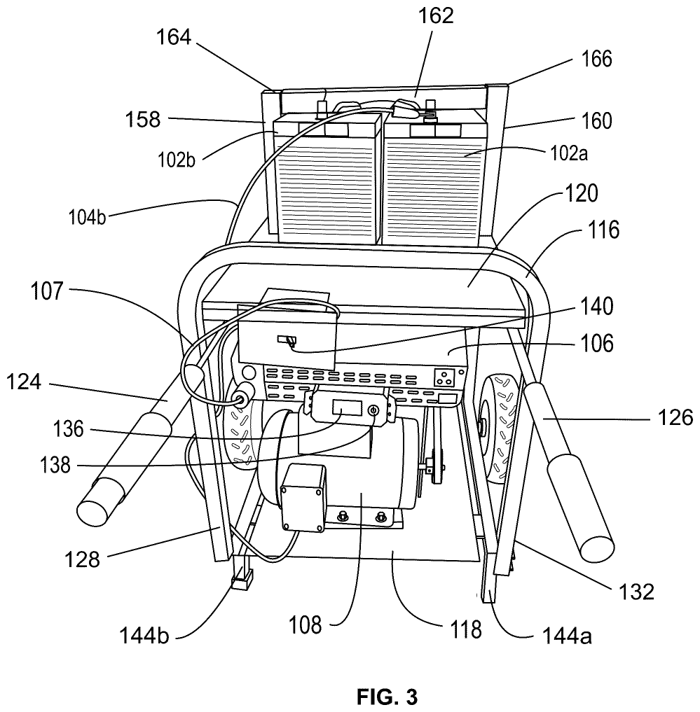

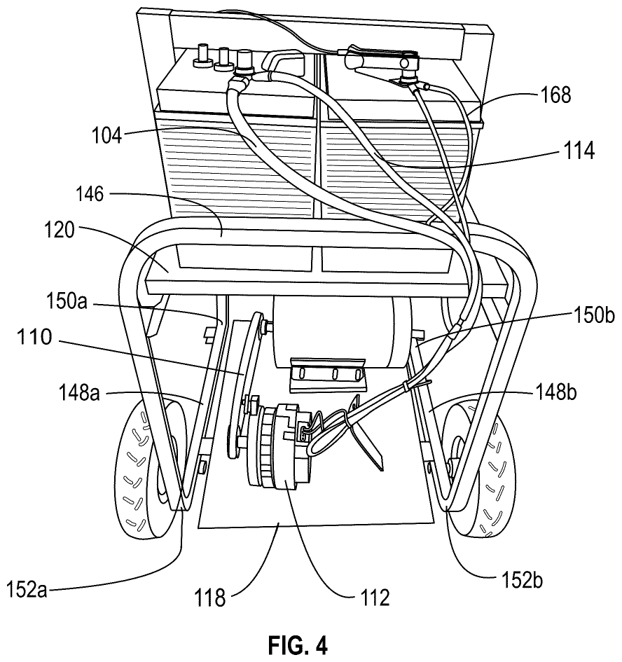

A battery system 102 is included in the generator device 100 for providing input D/C power The battery system 102 includes at least one battery device 102a. In a preferred embodiment, the battery system includes a second battery device 102b, as illustrated in FIGS. 3-4. Each individual battery device 102a, 102b is preferably a 12V DC battery, and in some embodiments, each battery device 102a, 102b can be of any desired power to accommodate the requirements of different users.

The battery system 102 is detachably disposed on the upper horizontal surface 120 of the frame 116.

In a preferred embodiment, the disclosed electric generator device 100 is portable. To secure the battery system 102 during movement of the frame 116 by a user and to prevent lateral movement of the battery system 102 relative to the upper horizontal surface 120, a protective frame 122 is preferably disposed on the upper horizontal surface 120 of the frame 116, as illustrated in FIGS. 1-4. As seen in FIG. 3, the protective frame 122 is preferably L-shaped, having a pair of vertical legs 158,160 and having a horizontal member 162 connecting the top ends 164,166 of the vertical legs 158,160. The pair of vertical legs 158,160 are preferably fixed atop the upper horizontal surface 120. The vertical legs 158,160 and the horizontal member 162 circumscribe a portion of the battery system 102, as illustrated in FIGS. 1-3.

In a preferred embodiment, the ground wire 168 and the power wire 104 are used with the battery system 102 to help prevent overheating and short circuiting of the electric generator device 100.

The battery system 102 of the electric generator device 100 provides the D/C power to an inverter 106 through an electrical wire 104, as shown in FIGS. 1-3. The electrical wire 104 is preferably insulated and is adapted to continuously feed D/C electric power from the battery system 102 to the inverter 106. The inverter 106 is adapted to convert the received D/C electric power from the battery system 102 into corresponding 115V A/C power.

In one embodiment, the self-powered electric generator device 100 includes a second inverter, and the two inverters are configured to convert the received D/C electric power into corresponding 230V A/C power. The references herein to 115V A/C means the system is designed to provide an output between 103.5 and 126.5 volts. Regarding references to the term 115V in this disclosure, the terms 110V, 115V, and 120V all refer to the same system voltage level. Regarding references to the term 230V in this disclosure, the terms 220V, 230V, and 240V all refer to the same system voltage level.

Referring to FIG. 3, in a preferred embodiment, the inverter 106 includes an inverter display 136 that is configured to display the power level and level of voltage of the A/C power generated by the inverter 106. It will be apparent to a person skilled in the art that the A/C power level can depend on the input D/C power level and further on the power rating (115V or 230V) of the inverter 106. A power button 138 is also preferably disposed on the display 136, preferably positioned on a front of the inverter 106, for manual activation and deactivation of the inverter 106, as exemplified in FIG. 3.

The A/C power from the inverter 106 drives the electric motor 108 as A/C power is transferred from the inverter 106 through an electrical wire 107, preferably through a switch 140, to the electric motor 108. The electric motor 108 is preferably a 115V or 230V A/C electric motor 108.

Upon receiving the A/C power from the inverter 106, the electric motor 108 performs a circular motion of its rotor (not shown) therein which drives a V-belt or drive belt 110, as shown in FIG. 2. In other words, the electric motor 108 drives the drive belt 110 by rotating the drive belt 110. The drive belt 110 is preferably a V-shape closed loop belt extending between the electric motor 108 and the alternator 112. As exemplified in FIG. 2, the drive belt 110 rotatably connects the electric motor 108 to an alternator 112. As the drive belt 110 continuously rotates due to its driven rotation of the electric motor 108, the drive belt 110 transfers to the alternator 112 the mechanical energy from the mechanical rotational motion of the electric motor 108.

The alternator 112 of the electric generator device 100 is configured to convert the mechanical energy from the drive belt 110 into electrical energy and preferably into D/C electric power. The alternator 112 is designed to be compatible with the battery system 102 of the electric generator device 100, and the generated D/C electric power from the alternator 112 is transferred through a alternator wire 114 to the battery system 102, as illustrated in FIG. 3, to recharge the battery system 102 (e.g., 102a, 102b), thereby forming a closed loop system for the electric generator device 100. The alternator 112 preferably generates 12V D/C electric power to recharge the battery system 102. The D/C electric power from the alternator 112 to the battery system 102 is transferred through the alternator wire 114 forming the closed loop.

In a preferred embodiment, the electric motor 108 has an associated electric motor power switch 140 adapted to activation and deactivate the electric motor 108, at the option of the user. The switch 140 is preferably a push button but can also be in the form of toggle switch or soft button.

As shown in FIGS. 3-4, the frame 116 preferably includes at least one wheel 134, and preferably two wheels 134, which are preferably 360-degree rotatable wheels connected to the horizontal members 148a, 148b that join the bottom ends 150a, 150b of the front wall 130 to bottom ends 152a, 152b of the rear wall 146, for easy transportability of the generator device 100. The frame 116 also preferably includes a pair of front stands 144a, 144b which provide upstanding support to the frame 116 when the device 100 is placed on a surface.

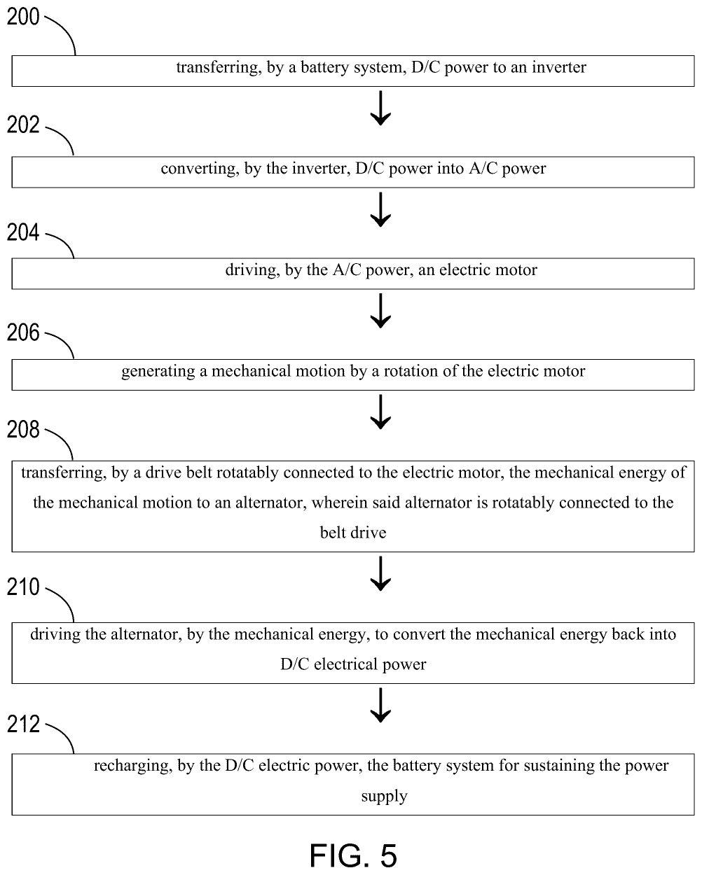

Referring to FIG. 5, herein disclosed is a method of generating electric power, including a step 200 of transferring, by a battery system 102, D/C power to an inverter 106. The method includes a step of converting, by the inverter 106, D/C power into A/C power. The method further includes a step of driving, by the A/C power, an electric motor 108. The method further includes a step of generating a mechanical motion by a rotation of the electric motor 108, and includes a step of transferring, by a drive belt 110 that is rotatably connected to the electric motor 108, the mechanical energy of the mechanical motion, to an alternator 112. The alternator 112 is rotatably connected to the belt drive 110, and thus, the method includes a step of driving the alternator 112 by the mechanical energy of the drive belt 110, to convert the mechanical energy into D/C electric power. The method further includes a step of recharging, by the D/C electric power, the battery system 102 for sustaining the power supply.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A self-sustaining electric generation system power system, comprising:
a battery system adapted to supply D/C power;
an inverter connected by at least a first wire to the battery system, said at least one wire adapted to supply D/C power from the battery system to the inverter, the inverter adapted to convert the D/C power into A/C power;
the inverter electrically connected by an electrical supply wire through a switch to an electric motor, the electric motor adapted to produce a mechanical motion from the A/C power supplied by said inverter;
a drive belt rotatably driven by said electric motor, said drive belt rotatably connected to an alternator and configured to transfer the mechanical motion to drive the alternator, the alternator adapted to convert the mechanical energy of the mechanical motion into an output D/C electric power, wherein said alternator is electrically connected by an alternator wire to the battery system, wherein said output D/C electric power is configured to recharge the battery system when fed back through the alternator wire by forming a closed loop adapted to produce continuous electrical power; and
a frame comprising a front wall and a rear wall, the frame comprising a lower horizontal surface and an upper horizontal surface, the lower horizontal surface and the upper horizontal surface both disposed between the front wall and the rear wall, the lower horizontal surface supporting the inverter, the electric motor, and the alternator thereon, the upper horizontal surface supporting the battery system thereon, the upper horizontal surface comprising a protective frame disposed around the battery system, said protective frame adapted to eliminate lateral movement of the battery system relative to the upper horizontal surface;
a pair of handles including a first handle connected to a first arm, said first arm pivotally connected to the front wall of the frame, the pair of handles including a second handle connected to a second arm, said second arm pivotally connected to the front wall of the frame.

2. The self-sustaining electric generation system of claim 1, wherein the frame comprises at least one wheel operatively connected to a lower portion of the frame.

3. The self-sustaining electric generation system of claim 1, wherein said battery system comprises a first 12V battery and a second 12V battery.

4. The self-sustaining electric generation system of claim 1, further comprising an inverter display configured to display a voltage of the A/C power, wherein the inverter display includes a seven-segment display and includes a power button adapted to activate and deactivate the inverter.

5. The self-sustaining electric generation system of claim 1, further comprising an electric motor power switch adapted to activate and deactivate the electric motor.

6. The self-sustaining electric generation system of claim 1, wherein the electric motor is adapted to generate 115V A/C power.

7. The self-sustaining electric generation system of claim 1, wherein the alternator is adapted to generate 12V D/C power for recharging the battery system.

8. A method of generating electric power, comprising:
transferring, by a battery system, D/C power to an inverter;
converting, by the inverter, D/C power into A/C power;
driving, by the A/C power, an electric motor;
generating a mechanical motion by a rotation of the electric motor;
transferring, by a drive belt rotatably connected to the electric motor, the mechanical energy of the mechanical motion to an alternator, wherein said alternator is rotatably connected to the belt drive;
driving the alternator, by the mechanical energy, to convert the mechanical energy back into D/C electric power; and
recharging, by the D/C electric power, the battery system for sustaining the power supply.
